(19) United States
(12) Patent Application Publication
(10) Pub. No.: US 2012/0036473 A1
(43) Pub. Date: Feb. 9, 2012

(54) METHOD AND SYSTEM TO CONTROL THE DISPLAY OF INFORMATION

(76) Inventors: Todd Haseyama, Encinitas, CA (US); Diane Lenore Guettier, Escondido, CA (US)

(21) Appl. No.: 13/260,342

(22) PCT Filed: May 27, 2009
(86) PCT No.: PCT/US09/45301

§ 371 Date: Sep. 25, 2011

(51) Int. Cl. G06F 3/048

(52) U.S. Cl. 715/784

(57) ABSTRACT

An exemplary embodiment of the present invention provides a system for displaying information. The system may include an input device, a display, and a processor. The processor may be configured to obtain an input from the input device and redraw a plurality of objects in a different location on the display in response to the input from the input device. The plurality of objects may extend beyond the display and the processor may be configured to indicate a logical break in the plurality of objects on the display.

### BACKGROUND

Early input and output devices for computers, such as punch cards and line printers, provided minimal interaction between the computer and the user. However, as input and output devices for computers have increased in complexity, the ability to simulate reality has provided an increasingly interactive user experience. For example, modern graphical user interfaces (GUIs) often simulate a desktop paradigm to provide efficient user interaction and control.

Continuing developments in input and output devices, such as touch screens, gyroscopic mice, and virtual reality systems, allow increased user immersion in a computing environment, but do not necessarily provide significant improvements in interaction over current GUIs. Accordingly, new paradigms for interaction with computing systems may be useful.

### BRIEF DESCRIPTION OF THE DRAWINGS

Certain exemplary embodiments are described in the following detailed description and in reference to the drawings, in which:

FIG. 1 is a perspective drawing of a touch screen computing device, in accordance with an exemplary embodiment of the present invention;

FIG. 2 is a functional block diagram of a computing device, in accordance with an exemplary embodiment of the present invention;

FIG. 3 is a perspective drawing of a printer/scanner/facsimile machine, in accordance with an exemplary embodiment of the present invention;

FIG. 4 is a diagram of a display showing a group of objects that extends beyond the borders of the display, in accordance with an exemplary embodiment of the present invention;

FIG. 5 is a diagram of a display that shows a group of objects including an indication of a logical break, in accordance with an exemplary embodiment of the present invention;

FIG. 6 is a diagram of a display showing the scrolling of a group of objects rebounding from a virtual detent, in accordance with an exemplary embodiment of the present invention;

FIG. 7 is a block diagram of a method for indicating logical breaks during the continuous scrolling of objects, in accordance with an exemplary embodiment of the present invention;

FIG. 8 is a diagram of a display showing an indication of a logical break at a virtual detent, in accordance with an exemplary embodiment of the present invention;

FIG. 9 is a diagram of a display showing another indication of a logical break at a virtual detent, in accordance with an exemplary embodiment of the present invention;

FIG. 10 is a diagram of a display showing another indication of a logical break at a virtual detent, in accordance with an exemplary embodiment of the present invention;

FIG. 11 is a diagram of a display showing another indication of a logical break at a virtual detent, in accordance with an exemplary embodiment of the present invention; and

FIG. 12 is a diagram of a display showing another indication of a logical break at a virtual detent, in accordance with an exemplary embodiment of the present invention.

### DETAILED DESCRIPTION OF SPECIFIC EMBODIMENTS

Advancing developments in input devices for computer systems have enabled the development of systems that may mimic real world physics. Accordingly, these systems make interacting with computing systems more intuitive, since the systems act as would be expected based on physical reality. For example, in the physical world, detents may be used to hold a mechanism in a certain position and may be released by applying force to move beyond the detent.

In an exemplary embodiment of the present invention, virtual detents are used in a graphical user interface to give a user more control over the navigation of objects in a scrollable group. The virtual detents can include visual, tactile, and/or aural cues to indicate logical breaks between the objects and, thus, mimic a physical detent mechanism. For example, a logical break may be a separation between the end of the group and the beginning of the group.

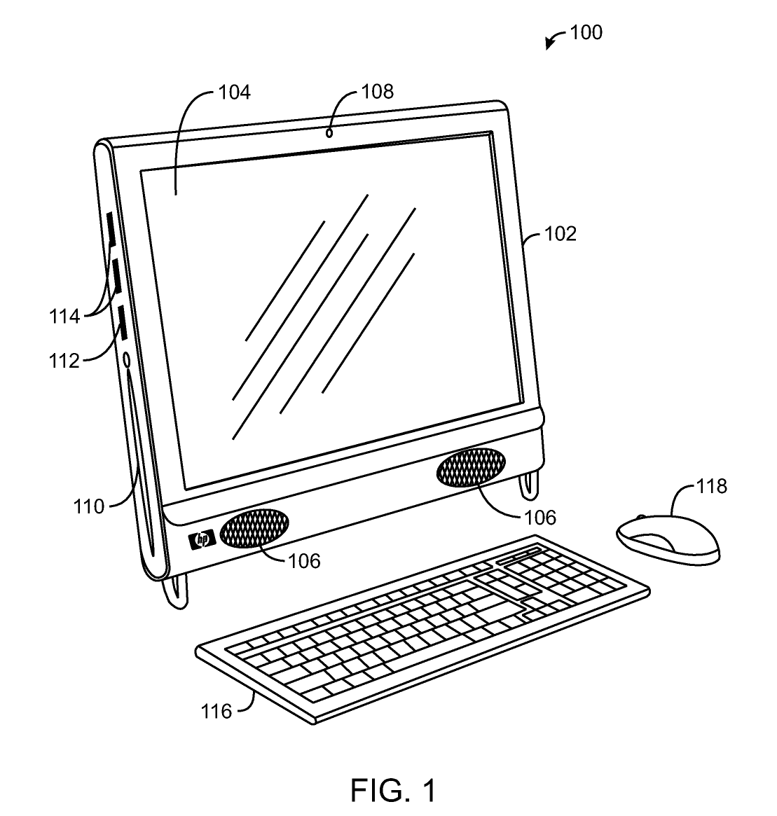

FIG. 1 is a perspective drawing of a touch screen computing device 100, in accordance with an exemplary embodiment of the present invention. The touch screen computing device 100 may have a single housing 102 that holds a touch screen monitor 104 and various input and output devices. For example, the housing 102 may hold speakers 106 and a camera 108. Further, the housing 102 may hold various data input devices, such as a CD-ROM 110 or other disk drives, and removable media interfaces, such as a USB port 112 and memory card slots 114. The touch screen monitor 102 may be used to control the display of groups of objects, for example, pictures downloaded from a memory card inserted into a memory card slot 114, filenames in one or more directories, graphics making up a two- or three-dimensional image, and the like.

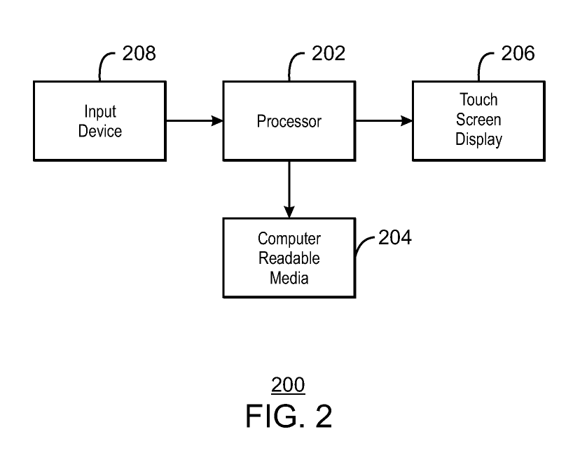

Although the touch screen 104 may be used for input to the system, the touch screen computing device 100 may also have a keyboard 116 and a mouse 118 for convention input. The touch screen computing device 100 may also have a haptic device (not shown), which may be used to vibrate the touch screen 104 as an additional feedback to the user. Numerous other devices may be included, as discussed with respect to FIG. 2.

FIG. 2 is a functional block diagram of a computing device 200, such as the touch screen computing device 100, discussed with respect to FIG. 1, in accordance with an exemplary embodiments of the present invention. The computing device 200 may have a processor 202 for booting the computing device 200 and running other programs. The computing device 200 will generally have computer readable media 204, for the processor 202 to store programs and data. The computer readable media 204 may include read only memory (ROM), which may store code intended for booting the computing device 200, among others. The ROM may include, for example, programmable ROM (PROM) and electrically programmable ROM (EPROM), among others. The computer readable media 204 may also include random access memory (RAM) for storing programs and data during operation of the computing device 200. Further, the computer readable media 204 may include units for longer term storage of programs and data, such as a hard drive or an optical disk drive. The computer readable media 206 may also include flash drives, which may be coupled to the computing device 200 through an external USB bus or may be memory cards inserted into a slot on the computing device.

The computing device 200 may have a coupled monitor, such as touch screen display 206, to display information from the computing device 200. Other output devices may also be included in the computing device 200, for example, an audio output device or a haptic device. Further, the computing device 200 may include various user input devices 208, for example, the touch screen 206, a keyboard or a mouse.

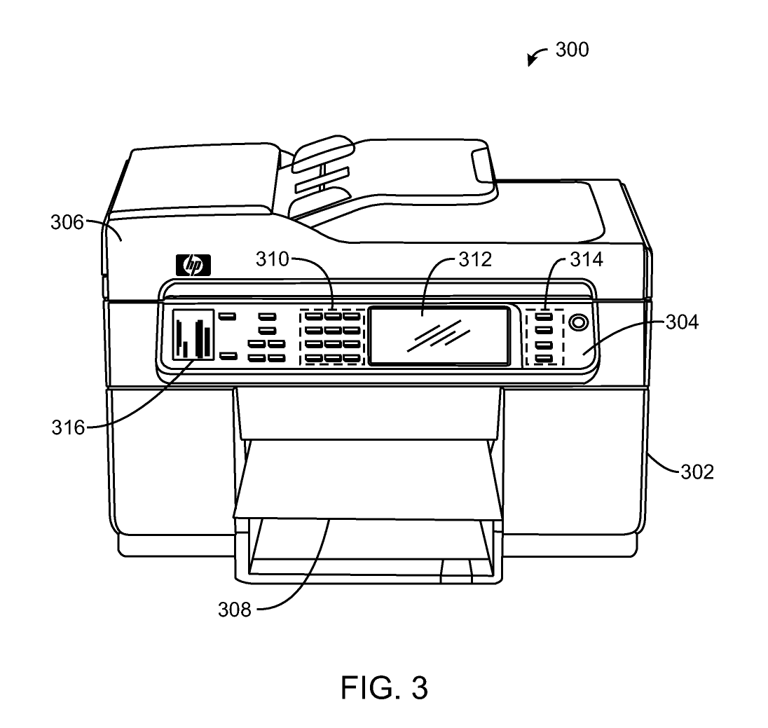

FIG. 3 is a perspective drawing of a printer/scanner/facsimile machine, commonly termed an all-in-one system 300, in accordance with an exemplary embodiment of the present invention. The all-in-one system 300 may have a single housing 302 that holds a control panel 304 and various input and output devices. For example, the housing 302 may hold a scanner 306 and a printer 308.

To control the operation of the all-in-one system 300, the control panel 304 may have one or more keypads, such as a phone keypad 310 for dialing. The control panel 304 may also have a touch screen display 312, which may be associated with one or more programmable keys 314. In an exemplary embodiment of the present invention, the control panel 304 may also have slots 316 for removable data storage media, such as memory cards and USB thumb drives. The touch screen display 312 may be used to control the display of groups of objects, for example, pictures downloaded from a memory card inserted into a slot 316. In conjunction with various input and output interfaces, the all-in-one system 300 may be used to scan and transmit documents over a network, print documents, send facsimiles, copy documents, and perform numerous other functions. For example, the all-in-one system 300 may be used to scroll through pictures stored on a memory card inserted into a slot 316, to allow the selection of pictures that may be printed, transmitted over a network, or sent as a facsimile transmission.

The touch screen display 312 may also have an associated haptic device (not shown), which may be used to vibrate the touch screen display 312 as an additional feedback to the user. Numerous other devices may be included, as discussed with respect to FIG. 3.

Exemplary embodiments of the present invention may include other devices in addition to those discussed above. For example, a display screen on a digital camera, for example, connected to a photo printer, may be used to display the group of objects and an arrow pad in proximately to the display screen may obtain user input for scrolling through the objects. In another exemplary embodiment, a virtual reality visor may be used to display the group of objects and an interactive glove can be used obtain user input for scrolling through the objects.

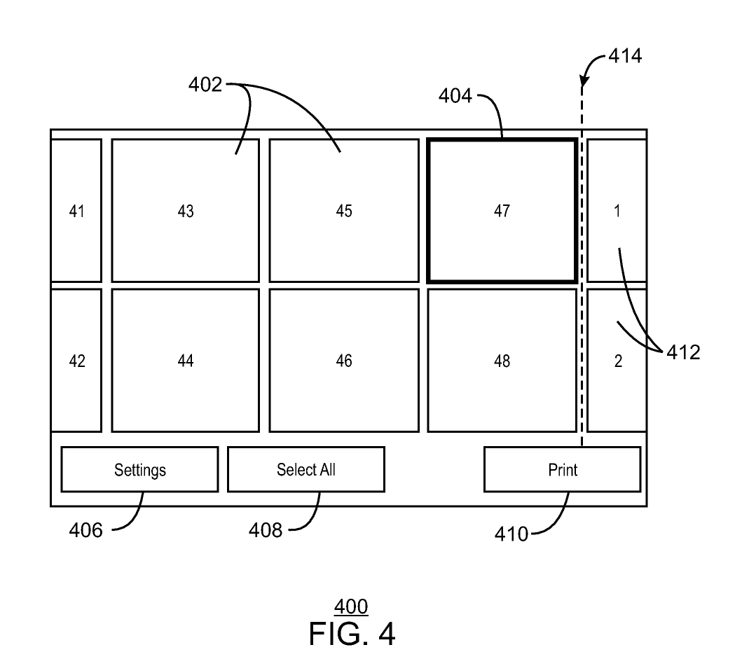

FIG. 4 is a diagram of a display 400 showing a group of objects 402 that extends beyond the borders of the display 400, in accordance with an exemplary embodiment of the present invention. If the display 400 is a touch screen, scrolling through the objects 402 may be performed by wiping a finger tip across the display 400 to the left or to the right. For example, a first wipe of a finger across the display 400 from the right to the left could start the group of objects 402 scrolling from the right to the left. More wipes of the finger tip across the display 400 in the same direction could be used to build “momentum,” in other words, to accelerate the scrolling rate of the objects 402. During periods where no contact is made with the display 400, the scrolling rate may be held constant or may be slowly decelerated to simulate the effects of friction. In other exemplary embodiments, scrolling may occur while the user is wiping a finger across the display and stop when then user is no longer in contact. If the speed of the scrolling becomes greater than the refresh rate of the display 400, simpler figures, such as boxes or lines, may be displayed to represent the objects 402 or a grey band may be shown in place of the objects 402. The input is not limited to a finger tip, as any appropriate input technique, for example, a stylus, could be used with an appropriate touch screen display 400. Further, scrolling could be controlled by conventional input devices, for example, a mouse initiating scrolling on a conventional monitor.

Individual objects 402 may be selected, for example, by touching the object 402 on the screen. An object 402 that is selected may be distinguished from other objects 402, such as by displaying a frame 404 around the object 402. Further, a selected object could be expanded to cover most, or all, of the display 400, for example, with objects 402 before and after the selected object partially shown at each edge of the display 400. The display 400 may also have controls for taking other actions. For example, the display 400 may show a settings button 406, which could be used to display controls, filenames, and other options. A select all button 408 could be used to select the entire group of objects 402. Other buttons could be used to perform specific actions on selected objects 406, such as a print button 410.

Generally, when either end of the group of objects 402 is reached, the scrolling will stop. The scrolling may stop immediately or may “rebound” from the end, in other words, stopping the scrolling and starting a slow scroll back in the opposite direction from the end. Stopping the scrolling at the ends forces a user to return to the opposite end of the group of objects 402 to see objects 402 that are proximate to that location. However, as modern storage media may hold a large amount of content, with some memory cards storing as many as 2000 or more pictures, it may be inconvenient to return to the opposite end. The scrolling of the objects 402 may wrap around to the opposite end, for example, restarting the scrolling of the objects from the beginning when the end is reached or from the end when the beginning is reached. This is shown in FIG. 4 by the partially visible objects 412 shown at the right edge of the display 400. However, wrapping the display of the objects 402 may allow the user to lose track of the current location, which may make finding desired objects 402 more difficult.

Accordingly, an exemplary embodiment of the present invention may provide an indication 414 of a logical break between objects 402 on the display 400. Such an indication 414 may be, for example, between the beginning and the end of the group of objects 402. Various logical breaks may be used to provide a useful indication 414, including breaks between objects 402 having different dates, objects 402 stored in different months, objects 402 stored under different topical designations (for example, in different folders), and the like.

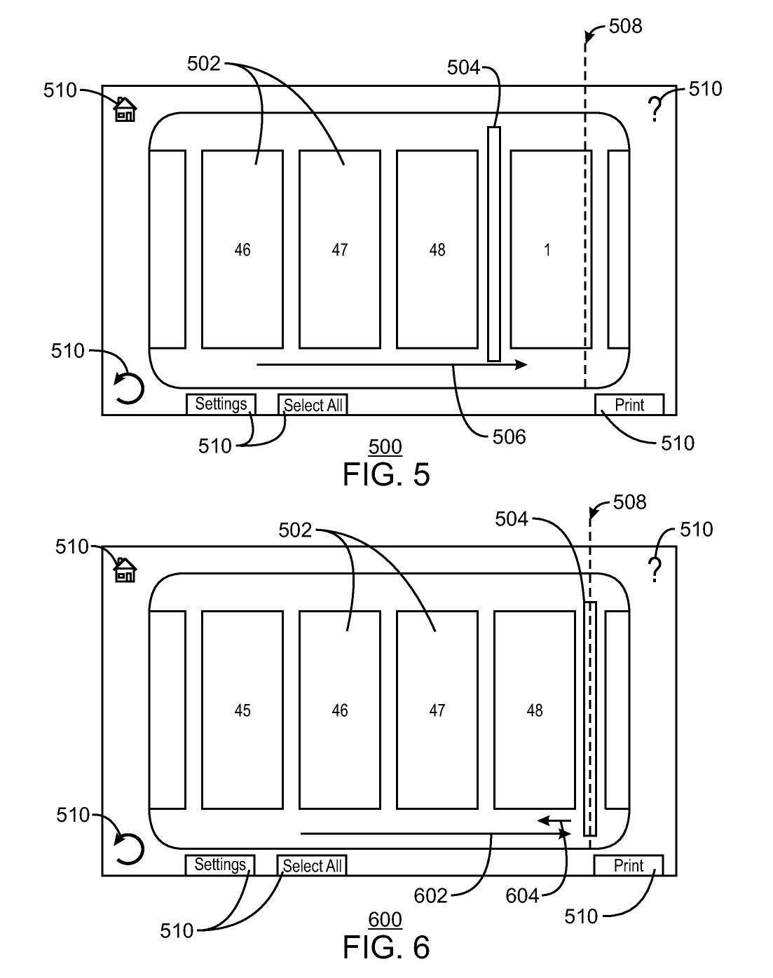

The indication 414 may comprise a line between the objects 402 at the logical break, an increase in spacing between the objects 402, or any number of other graphical, aural, or tactile features, as discussed further below. When the indication 414 of the logical break reaches a predetermined point on the display 400 (i.e., a virtual detent) the scrolling may slow or stop. The scrolling of the objects 402 may resume after the virtual detent, but may use an additional input from the user to force the scrolling of the objects through the virtual detent. This is discussed further with respect to FIGS. 5 and 6, below.

FIG. 5 is a diagram of a display 500 that shows a group of objects 502 including an indication 504 of a logical break, in accordance with an exemplary embodiment of the present invention. In FIG. 5, the group of objects 502 is scrolling from the left side of the display 500 to the right side of the display 500, as indicated by the arrow 506. When the indication 504 reaches a predetermined location 508 (i.e., the virtual detent) on the display 500, the scrolling may slow, stop or rebound. In this exemplary embodiment, the predetermined location 508 represents the location of the virtual detent. The virtual detent may be located at different points on the display 500 when scrolling in different directions. As discussed earlier, the display 500 may also show various controls 510 for selecting objects 502, printing objects 502, obtaining help, returning to previous pages, returning to central control screens, and the like.

FIG. 6 is a diagram of a display 600 showing the scrolling of a group of objects 502 rebounding when an indication 504 of a logical break reaches the predetermined location 508 (i.e., the virtual detent), in accordance with an exemplary embodiment of the present invention. As indicated by the larger arrow 602, the group of objects 502 is scrolling from left to right on the display 600. In this exemplary embodiment, when the indicator 504 reaches the predetermined location 508, the scrolling from left to right is halted, and a slow scroll from right to left may begin, as indicated by the smaller arrow 604. In other exemplary embodiments of the present invention, aural and or tactile indications may be simultaneously activated when the scrolling is halted. For example, a haptic device may vibrate the input device or an aural device may issue a sharp sound, such as a “click.” The user may then restart the scrolling of the objects from left to right by wiping a finger across the display 600 in that direction, allowing the scrolling of the group of objects 502 to continue across the virtual detent at the predetermined location 508.

The scrolling of the objects 502 is not limited to any particular direction, as the scrolling may be left-to-right, right-to-left, bottom-to-top, or top-to-bottom, depending on how the objects 502 are displayed. Further, if the objects 502 are arranged in a two-dimensional matrix that extends beyond the boundaries of the display 600, the user may initiate scrolling in a diagonal direction, with logical break point indicators and/or virtual detents located at the edge of the matrix of objects 602. The use of virtual detents is not limited to discrete matrices of objects 602. In an exemplary embodiment of the present invention, a continuous two-dimensional display may use a virtual detent to slow or stop scrolling when a logical break is reached. For example, a map that is continuously scrolled may have virtual detents set at defined boundaries, such as city limits, to slow or stop the scrolling. Other exemplary embodiments of the present invention may use virtual detents in a three-dimensional environment, such as a virtual reality display. This may be used to limit overshooting a target location, for example, to slow or stop the scrolling of an object when an edge is reached.

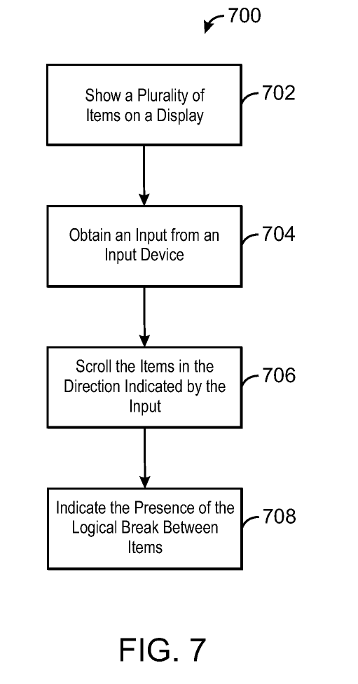

FIG. 7 is a block diagram of a method 700 for indicating logical breaks during the continuous scrolling of objects, in accordance with an exemplary embodiment of the present invention. The method 700 begins at block 702 with the display of a plurality of objects on a display. The plurality of objects may be one-dimensional, such as a text listing or a line of pictures, two-dimensional, such as a matrix of objects or a map, or three-dimensional, such as a display of an object in a three-dimensional CAD program. The objects may be displayed in any number of ways, for example, by downloading the objects from a website or by inserting a memory card that includes the objects into a device configured to automatically display the objects.

Once the objects are displayed, at block 704, a user input may be obtained, for example, from a touch screen display, a mouse, a keypad, and the like. The user input may indicate a selection of one or more objects or a command to act on one or more objects. The user input may also indicate a direction in which to scroll the display of the objects. At block 706, the objects are scrolled in a direction indicated by the user input. At block 708, a logical break between the objects is displayed. The logical break may indicate a logical separation point between objects, such as an end of the group of objects, objects collected during a different time period, objects in a different directory, a political border, an edge of an object, and the like. In an exemplary embodiment of the present invention, the scrolling may be slowed, halted, or reversed when the logical break reaches a predetermined point on a display, such as a virtual detent. Further, the scrolling may resume or continue past the logical break. For example, if the end of a directory listing has been reached, the user may continue the list at the beginning of the listing. As another example, if a boundary on a map, such as a city limit, has been reached, the user may resume or continue scrolling the map beyond the edge.

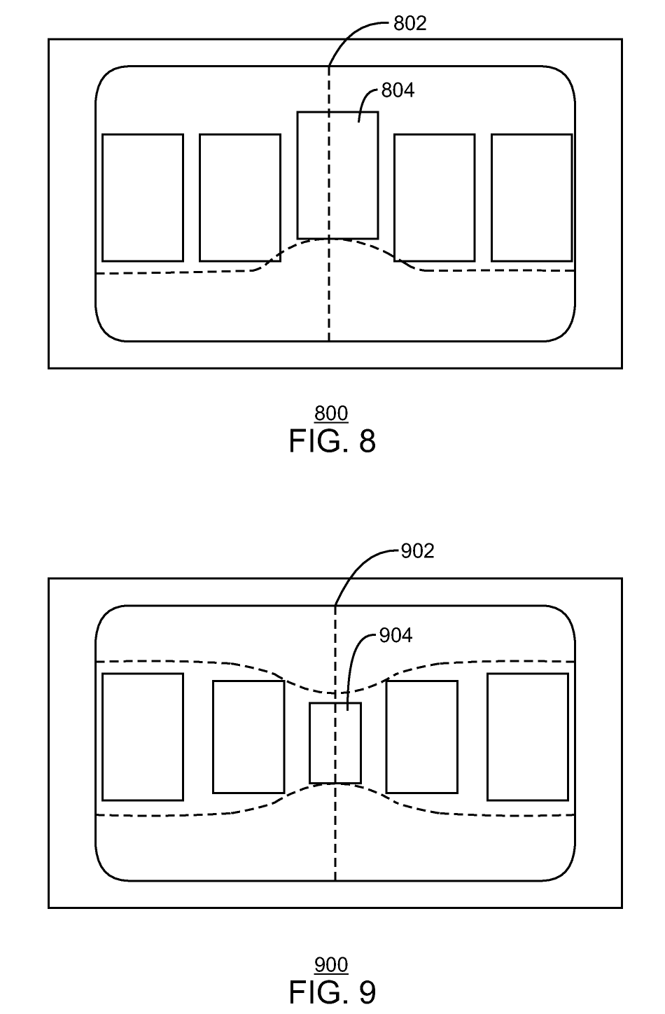

Any number of different visual effects may be useful to indicate when the logical break has reached the virtual detent, depending on system design considerations. For example, various effects that may be used in exemplary embodiments of the present invention are illustrated in FIGS. 8-12. The purpose of the different effects is to simulate a real environment for the user during the display of the virtual detent, for example, simulating a hill that may be rolled over to continue the scrolling or simulating a restriction that can be pushed through to continue the scrolling.

FIG. 8 is a diagram of a display 800 showing an indication of a logical break at a virtual detent 802 on a display screen, in accordance with an exemplary embodiment of the present invention. As shown in FIG. 8, an object 804 at the logical break may be elevated upon reaching the virtual detent 802. If the system is configured to stop or reverse scrolling when the virtual detent 802 is reached, the offset object 804 may drop back down in line with the other objects after the user indicates that scrolling should continue past the logical break. In another exemplary embodiment, the object may remain offset to indicate the location of the logical break as scrolling continues beyond the virtual detent 802.

FIG. 9 is a diagram of a display 900 showing another indication of a logical break at a virtual detent, in accordance with an exemplary embodiment of the present invention. In this diagram, a virtual detent 902 may be indicated on the display 900 by making an object 904 at the logical break smaller when the virtual detent 902 is reached. As for the virtual detent 802 illustrated in FIG. 8, the distortion of the object 904 may be removed when the user indicates that scrolling should continue past the logical break.

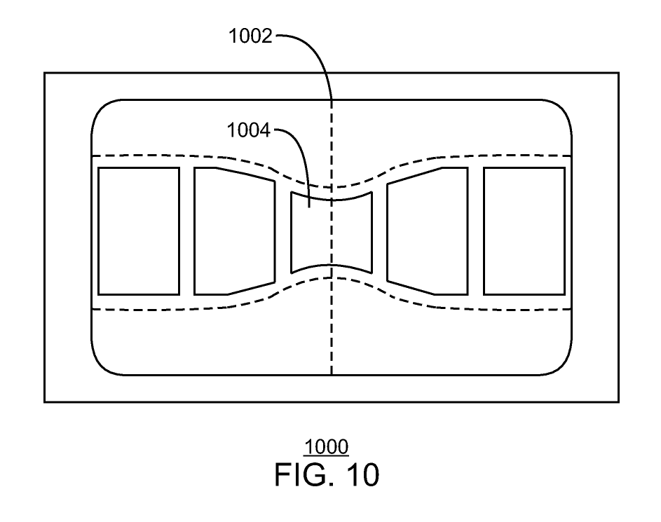

FIG. 10 is a diagram of a display 1000 showing another indication of a logical break at a virtual detent 1002, in accordance with an exemplary embodiment of the present invention. As shown in FIG. 10, an object 1004 may be distorted to indicate the presence of the virtual detent. As for the previous figures, the distortion may be removed after scrolling past the logical break or may be left to indicate the presence of the logical break.

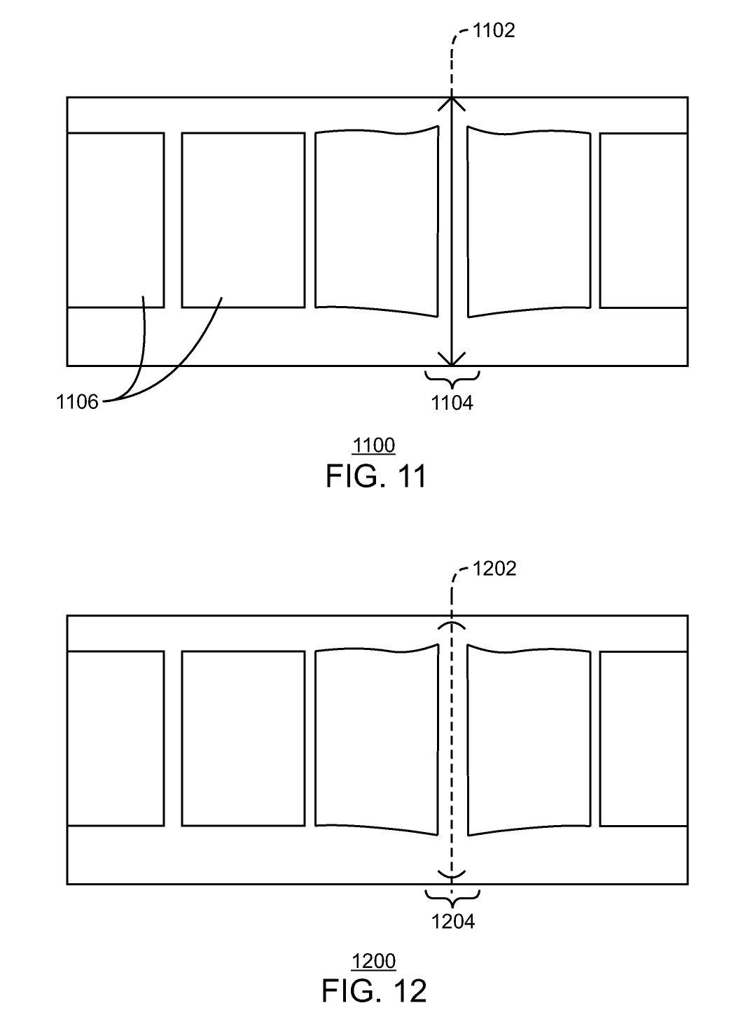

FIG. 11 is a diagram of a display 1100 showing another indication of a logical break at a virtual detent 1102, in accordance with an exemplary embodiment of the present invention. In this illustration, a virtual detent 1102 is indicated by showing a wall 1104 when the logical break reaches the virtual detent 1102. This embodiment may be accompanied by stopping or rebounding scrolling of objects 1106 when the logical break reaches the virtual detent 1102.

FIG. 12 is a diagram of a display 1200 showing another indication of a logical break at a virtual detent 1202, in accordance with an exemplary embodiment of the present invention. This exemplary embodiment may be similar to that illustrated in FIG. 11. However, in this diagram the virtual detent 1202 may be indicated as a softer break between objects 1204. Specifically, the scrolling may slow down as the logical break reaches the virtual detent 1202. This may provide a useful simulation of a hill that the scrolling can cross to continue. Any number of other visual, tactile, or aural indications of logical breaks may be used in exemplary embodiments of the present invention.

1. A method for controlling a display of information, comprising:
showing a plurality of objects on a display, wherein the plurality of objects extends beyond a border of the display, and wherein the plurality of objects comprises a logical break;
obtaining a user input from an input device, wherein the user input indicates a direction to scroll the plurality of objects on the display;
scrolling the objects in the direction indicated by the user input, wherein a logical break in the plurality objects is displayed; and
indicating the presence of the logical break in the plurality of objects on the display.

2. The method of claim 1, further comprising slowing or halting the scrolling the objects when the logical break reaches a predetermined point on the display.

3. The method of claim 1, further comprising reversing the scrolling of objects when the logical break reaches a predetermined point on the display.

4. The method of claim 1 further comprising:
obtaining a second user input to continue the scrolling of objects in the direction indicated by the user input; and
resuming the scrolling of objects beyond the logical break in the direction indicated by the user input.

5. The method of claim 1, wherein the logical break comprises a point separating the end of the plurality of objects from the beginning of the plurality of objects.

6. The method of claim 1, wherein the logical break comprises a separation in the plurality of objects by a timeframe, a directory, a topic, a file type, a file size, or any combinations thereof.

7. The method of claim 1, wherein the plurality of objects forms a continuous two-dimensional or three-dimensional matrix.

8. The method of claim 1, comprising continuously scrolling the objects until a user provides an input to stop the scrolling.

9. The method of claim 1, further comprising increasing the speed of the scrolling of the objects based at least in part upon a second user input.

10. The method of claim 1, further comprising: reading the plurality of objects from a memory card.

11. A system for displaying information, comprising:
an input device;
a display;
a processor configured to obtain an input from the input device and redraw a plurality of objects in a different location on the display in response to the input from the input device, wherein the plurality of objects extends beyond the display, and wherein the processor is configured to indicate a logical break in the plurality of objects on the display.

12. The system of claim 11, wherein the input device and display comprise a touch sensitive screen,

13. The system of claims 11, further comprising a memory card reader configured to accept a memory card comprising the plurality of objects.

14. The system of any of claims 11, further comprising slowing, stopping, or reversing a scrolling of objects across the display when the logical break reaches a predetermined point on the screen,

15. A system for displaying information, comprising:
a means for showing a plurality of objects on a display, wherein the plurality of objects extends beyond a border of the display, and wherein the plurality of objects comprises a logical break;
a means for obtaining a user input from an input device, wherein the user input indicates a direction to scroll the plurality of objects on the display;
a means for scrolling the objects in the direction indicated by the user input, wherein a logical break in the plurality objects is displayed; and
a means for indicating the presence of the logical break in the plurality of objects on the display.
